(19) United States
(12) Patent Application Publication
(10) Pub. No.: US 2021/0280182 A1
(43) Pub. Date: Sep. 9, 2021

(54) METHOD OF PROVIDING INTERACTIVE ASSISTANT FOR EACH SEAT IN VEHICLE

(71) Applicant: LG ELECTRONICS INC., Seoul (KR)

(72) Inventors: Hyeonsik CHOI, Seoul (KR); Junmin LEE, Seoul (KR); Keunsang LEE, Seoul (KR)

(73) Assignee: LG ELECTRONICS INC., Seoul (KR)

(21) Appl. No.: 17/069,508

(22) Filed: Oct. 13, 2020

(30) Foreign Application Priority Data
Mar. 6, 2020 (KR) 10-2020-0028135

(51) Int. Cl. G10L 15/22; H04R 3/00; G10L 25/03

(52) U.S. Cl. CPC G10L 15/22; H04R 2203/12; G10L 25/03; H04R 3/005

(57) ABSTRACT

Method and device of providing an interactive assistant for each seat in a vehicle are provided. The method of providing an interactive assistant for each seat in a vehicle, including receiving a plurality of voice signals through a beamformed microphone array for a plurality of regions preset in a vehicle and generating and selecting at least one cluster using the plurality of voice signals. Accordingly, the interactive assistant capable of removing a noise and realizing enhanced convenience can be provided. The vehicle of the present disclosure may be associated with an artificial intelligence module, an unmanned aerial vehicle (UAV), a robot, an augmented reality (AR) device, a virtual reality (VR) device, and a device related to a 5G service.

### CROSS-REFERENCE TO RELATED APPLICATION(S)

Pursuant to 35 U.S.C. § 119(a), this application claims the benefit of earlier filing date and right of priority to Korean Patent Application No. 10-2020-0028135, filed on Mar. 6, 2020, the contents of which are hereby incorporated by reference herein in its entirety.

### BACKGROUND OF THE DISCLOSURE

### Field of the Disclosure

The present disclosure relates to a method and an apparatus of providing an interactive assistant for each seat in a vehicle.

### Related Art

Machine learning is an algorithm technique that it itself may classify and learn the features of input data. The component technology is a technique for mimicking the human brain's perception and decision capabilities using a machine learning algorithm (e.g., deep learning), and this may be divided into several technical fields, such as linguistic understanding, visual understanding, inference/prediction, knowledge expression, and operation control.

Meanwhile, when two or more users utter commands for different speech recognition devices in a narrow space, there is a problem that the speech recognition device cannot classify and recognize the command by each of the two or more users.

### SUMMARY OF THE DISCLOSURE

The present disclosure aims to address the above-mentioned need and/or problem.

The present disclosure also provides a method and an apparatus for providing an interactive assistant for each seat in a vehicle capable of distinguishing and recognizing voice commands by a plurality of users and providing different services according to a recognition result.

The present disclosure also provides a method and an apparatus of providing an interactive assistant for each seat in a vehicle capable of removing a noise which may be received during a speech recognition process by setting a beamforming region of a microphone array at each location of a plurality of users.

The present disclosure also provides a method and an apparatus of providing an interactive assistant for each seat in a vehicle capable of collecting source data for a voice and/or a noise of a plurality of users, and recording learning data of a learning model for determining any one of the plurality of users by using the collected source data.

The present disclosure also provides a method and an apparatus of providing an interactive assistant for each seat in a vehicle capable of separating and recognizing a sound source generated in a specific space using a learning model trained based on a voice and/or a noise of a plurality of users.

The present disclosure also provides a method and an apparatus of providing an interactive assistant for each seat in a vehicle capable of providing a service adapted to each of a plurality of users.

In an aspect, there is provided a method of providing an interactive assistant for each seat in a vehicle, the method including: receiving a plurality of voice signals through a beamformed microphone array for a plurality of regions preset in a vehicle; generating at least one cluster using the plurality of voice signals; selecting a cluster associated with the voice signal received in a specific direction out of the at least one cluster, and extracting information from the voice signal included in the selected cluster; and generating a control signal corresponding to the extracted information.

Moreover, the microphone array may be disposed in a central region of a plurality of seats based on positions of the plurality of seats constituting an inside of the vehicle.

The microphone array may be disposed at a center inside the vehicle.

The specific direction may be an input direction of a voice signal which is transmitted from a position of any one of the plurality of seats located inside the vehicle toward the microphone array.

The microphone array may be beamformed so as to correspond to respective positions of the plurality of seats located inside the vehicle.

The microphone array may include a first to fourth microphones, a first sub microphone array including the first and second microphones may be a sub microphone array beamformed to a region mapped to at least one seat located at a first region of the vehicle, and a second sub microphone array including the third and fourth microphones may be a sub microphone array beamformed to a region mapped to at least one seat located at a second region of the vehicle.

The at least one seat located in the first region and the at least one seat located in the second region may be disposed to face each other.

The information extracted from the voice signal may include user identification information detected from utterance characteristics of a user, and the control signal may be a signal which controls at least one component provided in a vehicle cabin system.

The generating of the control signal may include selecting a user model matching the extracted information, and generating a signal for controlling the vehicle cabin system to provide a specific service in the order of preference of the user using the selected user model, and the user model may be a learning model based on an artificial neural network which is supervision-learned to output a user preference for a plurality of services provided through the vehicle cabin system when the user identification information is received as an input.

The user model may be a learning model in which weight is adjusted so that a higher preference is given to a service having a high use frequency of the user.

The microphone array may be beamformed to the plurality of regions based on Superdirective Beamforming.

The method may further include, when a voice signal is received from one region of the plurality of regions, determining that a user boards one region in response to receiving the voice signal; and activating a vehicle cabin system associated with the one region in response to the boarding of the user.

The method may further include combining location information of the one region with the plurality of received voice signals or the at least one cluster.

In another aspect, there is provided a vehicle including: a microphone array configured to be beamformed to a plurality of regions preset in the vehicle; and a controller configured to generate at least one cluster using a plurality of voice signals received from the microphone array, select a cluster associated with the voice signal received in a specific direction out of the at least one cluster and extract information from the voice signal included in the selected cluster, and generate a control signal corresponding to the extracted information.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of an autonomous vehicle and a 5G network in a 5G communication system.

FIG. 4 is a diagram illustrating a block diagram of an electronic device.

FIG. 5 illustrates a schematic block diagram of an AI server according to an embodiment of the present disclosure.

FIG. 6 illustrates a schematic block diagram of an AI device according to another embodiment of the present disclosure.

FIG. 7 is a conceptual diagram illustrating an embodiment of an AI device.

FIG. 8 is a diagram showing a vehicle according to an embodiment of the present disclosure.

FIG. 9 is a control block diagram of the vehicle according to an embodiment of the present disclosure.

FIG. 10 is a diagram showing the interior of the vehicle according to an embodiment of the present disclosure.

FIG. 11 is a block diagram referred to in description of a cabin system for a vehicle according to an embodiment of the present disclosure.

FIG. 12 is a diagram referred to in description of a usage scenario of a user according to an embodiment of the present disclosure.

FIG. 13 is a flowchart illustrating a method of providing an interactive assistant for each seat in a vehicle according to an embodiment of the present disclosure.

FIG. 14 is a flowchart illustrating an example of S140 in FIG. 13 of the present disclosure.

FIG. 15 is a flowchart illustrating another example of S140 in FIG. 13 of present disclosure.

FIG. 16 is a flowchart illustrating a method of controlling activation of an interactive assistant function of the present disclosure.

FIGS. 17 to 19 are views for explaining an implementation of a beamforming method according to various embodiments of the present disclosure.

FIGS. 20 to 26 are exemplary views illustrating an implementation of a method of providing an interactive assistant.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

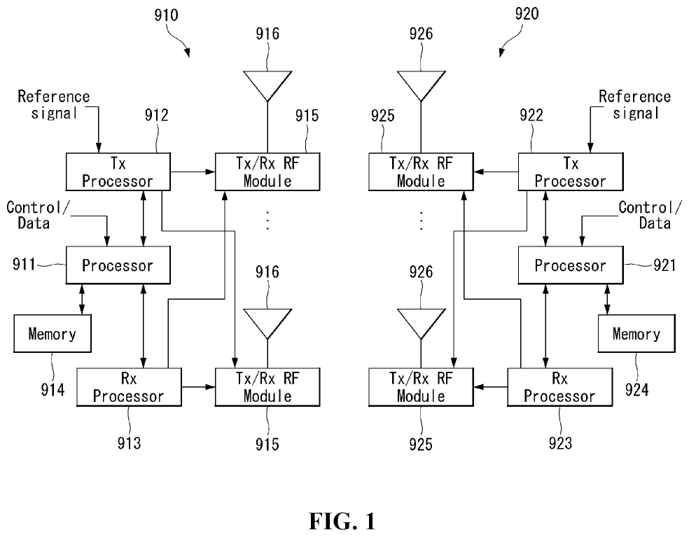

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

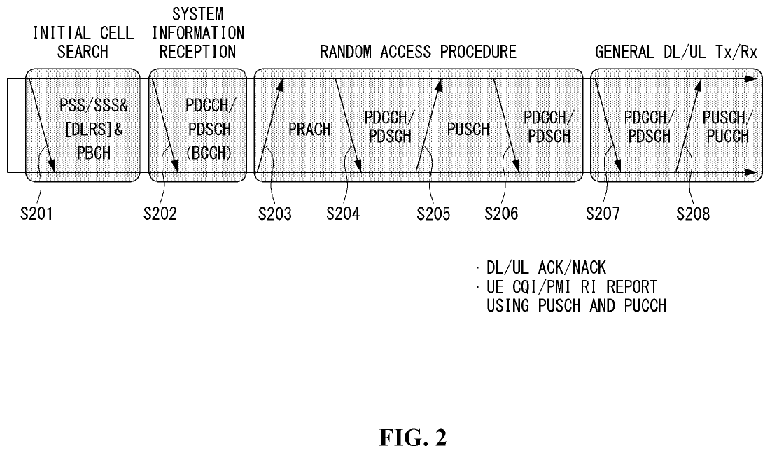

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between User Equipments Using 5G Communication

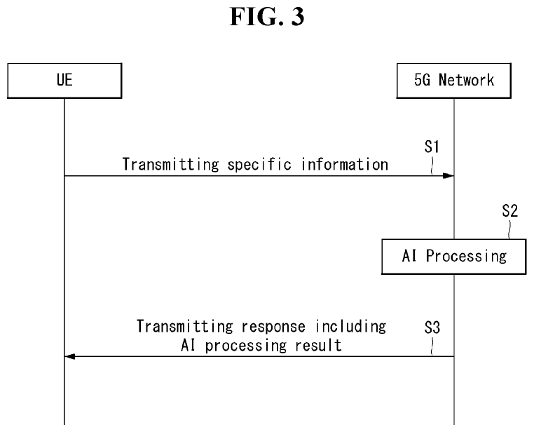

FIG. 3 shows an example of basic operations of a user equipment and a 5G network in a 5G communication system.

The user equipment transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the user equipment (S3).

G. Applied Operations Between User Equipment and 5G Network in 5G Communication System

Hereinafter, the operation of a user equipment using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the user equipment performs an initial access procedure and a random access procedure with the 5G network prior to step S1 of FIG. 3 in order to transmit/receive signals, information and the like to/from the 5G network.

More specifically, the user equipment performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the user equipment receives a signal from the 5G network.

In addition, the user equipment performs a random access procedure with the 5G network for UL synchronization acquisition and/or UL transmission. The 5G network can transmit, to the user equipment, a UL grant for scheduling transmission of specific information. Accordingly, the user equipment transmits the specific information to the 5G network on the basis of the UL grant. In addition, the 5G network transmits, to the user equipment, a DL grant for scheduling transmission of 5G processing results with respect to the specific information. Accordingly, the 5G network can transmit, to the user equipment, information (or a signal) related to remote control on the basis of the DL grant.

Next, a basic procedure of an applied operation to which a method proposed by the present invention which will be described later and URLLC of 5G communication are applied will be described.

As described above, a user equipment can receive DownlinkPreemption IE from the 5G network after the user equipment performs an initial access procedure and/or a random access procedure with the 5G network. Then, the user equipment receives DCI format 2_1 including a preemption indication from the 5G network on the basis of DownlinkPreemption IE. The user equipment does not perform (or expect or assume) reception of eMBB data in resources (PRBs and/or OFDM symbols) indicated by the preemption indication. Thereafter, when the user equipment needs to transmit specific information, the user equipment can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the user equipment receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the user equipment transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

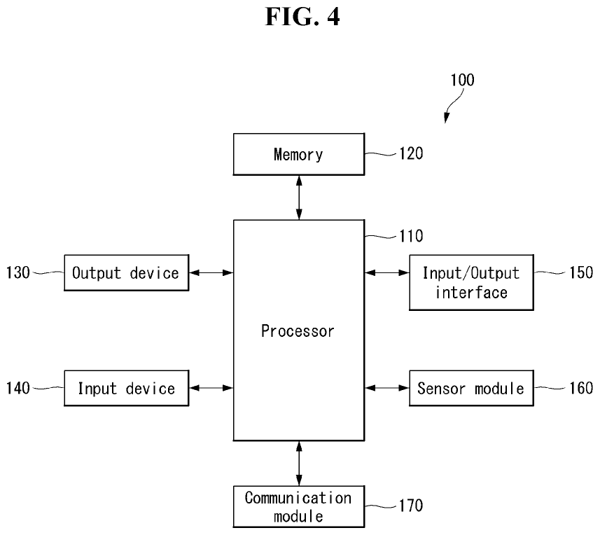

FIG. 4 is a diagram illustrating a block diagram of an electronic device.

Referring to FIG. 4, an electronic device 100 may include at least one processor 110, a memory 120, an output device 130, an input device 140, an input/output interface 150, a sensor module 160, and a communication module 170.

The processor 110 may include one or more application processors (AP), one or more communication processors (CP), or at least one or more artificial intelligence processors (AI processors). The application processor, the communication processor, or the AI processor may be included in different integrated circuit (IC) packages, respectively, or may be included in one IC package.

The application processor may run an operating system or an application program to control a plurality of hardware or software components connected to the application processor, and perform various data processing/operations including multimedia data. As an example, the application processor may be implemented as a system on chip (SoC). The processor 110 may further include a graphic processing unit (GPU) (not shown).

The communication processor may perform functions of managing data links and converting a communication protocol in communication between the electronic device 100 and other electronic devices connected through a network. As an example, the communication processor may be implemented as an SoC. The communication processor may perform at least some of the multimedia control functions.

In addition, the communication processor may control data transmission and reception of the communication module 170. The communication processor may be implemented to be included as at least a part of the application processor.

The application processor or the communication processor may load and process a command or data received from at least one of a nonvolatile memory or other components connected to each to a volatile memory. Also, the application processor or the communication processor may store data received from at least one of the other components or generated by at least one of the other components in the nonvolatile memory.

The memory 120 may include an internal memory or an external memory. The internal memory may include at least one of the volatile memory (for example, dynamic RAM (DRAM), static RAM (SRAM), synchronous dynamic RAM (SDRAM), etc.) or the nonvolatile memory (for example, one time programmable ROM (OTPROM), programmable ROM (PROM), erasable and programmable ROM (EPROM), electrically erasable and programmable ROM (EEPROM), mask ROM, flash ROM, NAND flash memory, NOR flash memory, etc.). According to an embodiment, the internal memory may take the form of a solid state drive (SSD). The external memory may further include a flash drive, for example, compact flash (CF), secure digital (SD), micro secure digital (Micro-SD), mini secure digital (Mini-SD), and extreme digital (xD) or a memory stick, etc.

The output device 130 may include at least one or more of a display module and a speaker. The output device 130 may display various types of data including multimedia data, text data, voice data, and the like to a user or output it as sound.

The input device 140 may include a touch panel, a digital pen sensor, a key, or an ultrasonic input device, etc. For example, the input device 140 may be the input/output interface 150. The touch panel may recognize a touch input using at least one of a capacitive type, a pressure sensitive type, an infrared type, or an ultrasonic type. In addition, the touch panel may further include a controller (not shown). In the case of capacitive type, not only direct touch but also proximity recognition is possible. The touch panel may further include a tactile layer. In this case, the touch panel may provide a tactile reaction to the user.

The digital pen sensor may be implemented using the same or similar method as receiving a user's touch input, or using a separate recognition layer. Keys may be keypads or touch keys. The ultrasonic input device is a device that can check data by detecting a micro sound wave in a terminal through a pen that generates an ultrasonic signal, and is capable of wireless recognition. The electronic device 100 may receive a user input from an external device (e.g. a network, a computer, or a server) connected thereto by using the communication module 170.

The input device 140 may further include a camera module and a microphone. The camera module is a device capable of capturing images and moving pictures, and may include one or more image sensors, an image signal processor (ISP), or a flash LED. The microphone may receive an audio signal and convert it into an electrical signal.

The input/output interface 150 may transmit commands or data input from the user through the input device or the output device to the processor 110, the memory 120, the communication module 170, etc. through a bus (not shown). For example, the input/output interface 150 may provide data on a user's touch input entered through the touch panel to the processor 110. For example, the input/output interface 150 may output commands or data received from the processor 110, the memory 120, the communication module 170, etc. through the bus through the output device 130. For example, the input/output interface 150 may output voice data processed through the processor 110 to the user through the speaker.

The sensor module 160 may include at least one of a gesture sensor, a gyro sensor, an atmospheric pressure sensor, a magnetic sensor, an acceleration sensor, a grip sensor, a proximity sensor, an RGB (red, green, blue) sensor, a biometric sensor, a temperature/humidity sensor, an illuminance sensor and an ultra violet (UV) sensor. The sensor module 160 may measure a physical quantity or detect an operating state of the electronic device 100 and convert the measured or detected information into an electric signal. Additionally or alternatively, the sensor module 160 may include an olfactory sensor (E-nose sensor), an EMG sensor (electromyography sensor), an EEG sensor (electroencephalogram sensor, not shown), an ECG sensor (electrocardiogram sensor), a PPG sensor (photoplethysmography sensor), a heart rate monitor sensor (HRM), a perspiration sensor or a fingerprint sensor, etc. The sensor module 160 may further include a control circuit for controlling at least one or more sensors included therein.

The communication module 170 may include a wireless communication module or an RF module. The wireless communication module may include, for example, Wi-Fi, BT, GPS or NFC. For example, the wireless communication module may provide a wireless communication function using a radio frequency. Additionally or alternatively, the wireless communication module may include a network interface or modem for connecting the electronic device 100 to a network (example: internet, LAN, WAN, telecommunication network, cellular network, satellite network, POTS or 5G network, etc.).

The RF module may be responsible for transmission and reception of data, for example, transmission and reception of RF signals or called electronic signals. For example, the RF module may include a transceiver, a power amp module (PAM), a frequency filter or a low noise amplifier (LNA), etc. In addition, the RF module may further include components for transmitting and receiving an electromagnetic wave in a free space in wireless communication, for example, a conductor or a wire.

The electronic device 100 according to various embodiments of the present disclosure may include at least one of a server, a TV, a refrigerator, an oven, a clothing styler, a robot cleaner, a drone, an air conditioner, an air cleaner, a PC, a speaker, a home CCTV, a lighting, a washing machine and a smart plug. Since the components of the electronic device 100 described in FIG. 4 are examples of components generally included in the electronic device, the electronic device 100 according to the embodiment of the present disclosure is not limited to the above-described components, and may be omitted and/or added as necessary.

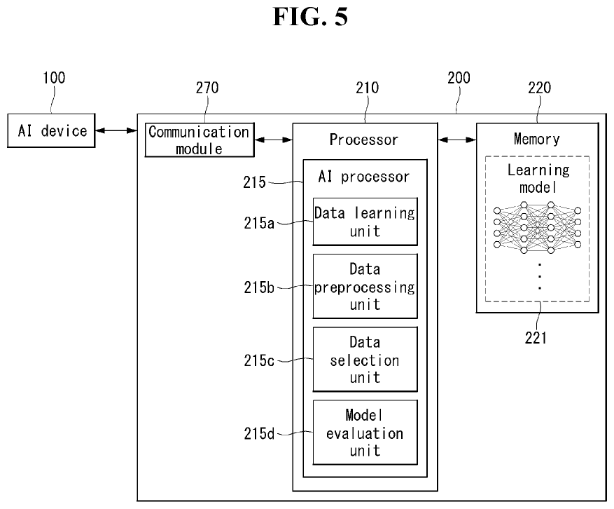

The electronic device 100 may perform an artificial intelligence-based control operation by receiving the AI processing result from the cloud environment shown in FIG. 5 or may include an AI module in which components related to the AI process are integrated into one module to perform AI processing in an on-device method.

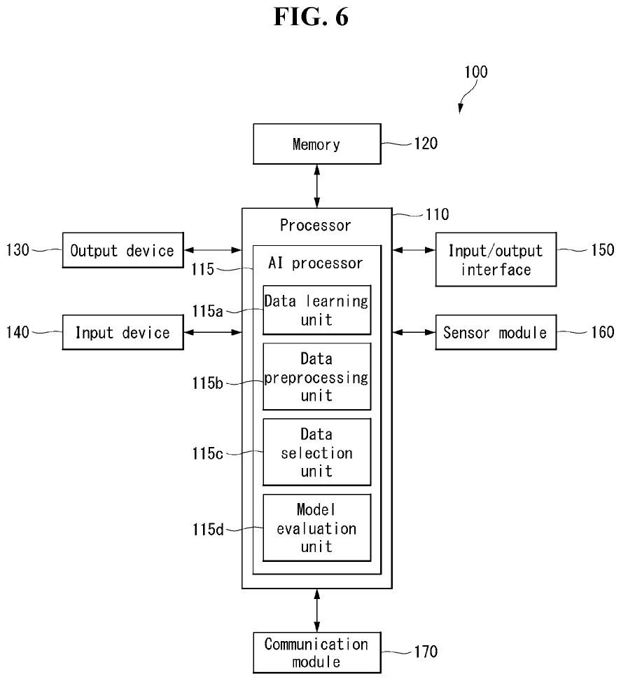

Hereinafter, an AI process performed in a device environment and/or a cloud environment or a server environment will be described through FIGS. 5 and 6. FIG. 5 illustrates an example in which receiving data or signals may be performed in the electronic device 100, but AI processing to process input data or signals may be performed in a cloud environment. In contrast, FIG. 6 illustrates an example of on-device processing in which the overall operation related to AI processing for input data or signals is performed in the electronic device 100.

In FIGS. 5 and 6, the device environment may be referred to as ‘client device’ or ‘AI device’, and the cloud environment may be referred to as ‘server’ or ‘AI server’.

FIG. 5 illustrates a schematic block diagram of an AI server according to an embodiment of the present disclosure.

A server 200 may include a processor 210, a memory 220, and a communication module 270.

An AI processor 215 may learn a neural network using a program stored in the memory 220. In particular, the AI processor 215 may learn a neural network for recognizing data related to an operation of an AI device 100. Here, the neural network may be designed to simulate a human brain structure (e.g. a neuron structure of a human neural network) on a computer. The neural network may include an input layer, an output layer, and at least one hidden layer. Each layer may include at least one neuron having a weight, and the neural network may include a synapse connecting neurons and neurons. In the neural network, each neuron may output an input signal input through the synapse as a function value of an activation function for weight and/or bias.

A plurality of network nodes may exchange data according to each connection relationship so that the neurons simulate synaptic activity of neurons that exchange signals through synapses. Here, the neural network may include a deep learning model developed from a neural network model. In the deep learning model, a plurality of network nodes may exchange data according to a convolutional connection relationship while being located in different layers. Examples of neural network models may include various deep learning techniques such as a deep neural network (DNN), a convolutional neural network (CNN), a recurrent neural network, a restricted Boltzmann machine, and a deep belief network, a deep Q-Network, and may be applied in fields such as vision recognition, speech recognition, natural language processing, and voice/signal processing.

Meanwhile, the processor 210 performing the functions as described above may be a general-purpose processor (e.g. a CPU), but may be an AI dedicated processor (e.g. a GPU) for artificial intelligence learning.

The memory 220 may store various programs and data required for the operation of the AI device 100 and/or the server 200. The memory 220 may be accessed by the AI processor 215, and may read/write/edit/delete/update data by the AI processor 215. In addition, the memory 220 may store a neural network model (e.g. a deep learning model) generated through a learning algorithm for data classification/recognition according to an embodiment of the present disclosure. Furthermore, the memory 220 may store not only the learning model 221 but also input data, learning data, and learning history, etc.

Meanwhile, the AI processor 215 may include a data learning unit 215a for learning a neural network for data classification/recognition. The data learning unit 215a may learn a criterion for which learning data to use in order to determine data classification/recognition and how to classify and recognize data using the learning data. The data learning unit 215a may learn the deep learning model by acquiring learning data to be used for learning and applying the acquired learning data to the deep learning model.

The data learning unit 215a may be manufactured in the form of at least one hardware chip and mounted on the server 200. For example, the data learning unit 215a may be manufactured in the form of a dedicated hardware chip for artificial intelligence, and may be manufactured as a part of a general-purpose processor (CPU) or a graphics dedicated processor (GPU) and mounted on the server 200. Further, the data learning unit 215a may be implemented as a software module. When implemented as a software module (or a program module including an instruction), the software module may be stored in a computer-readable non-transitory computer readable media. In this case, at least one software module may be provided to an operating system (OS) or may be provided by an application.

The data learning unit 215a may learn to have a criterion for determining how a neural network model classifies/recognizes predetermined data using the acquired learning data. In this case, the learning method by the model learning unit may be classified into supervised learning, unsupervised learning, and reinforcement learning. Here, the supervised learning may refer to a method of learning an artificial neural network in a state where a label for learning data is given, and the label may mean a correct answer (or result value) that the artificial neural network must infer when the learning data is input to the artificial neural network. The unsupervised learning may mean a method of learning an artificial neural network in a state where a label for learning data is not given. The reinforcement learning may mean a method in which an agent defined in a specific environment learns to select an action or action sequence that maximizes the cumulative reward in each state. In addition, the model learning unit may learn the neural network model using a learning algorithm including an error backpropagation method or a gradient decent method. When the neural network model is learned, the learned neural network model may be referred to as a learning model 221. The learning model 221 may be stored in the memory 220 and used to infer a result of new input data other than the learning data.

On the other hand, in order to improve the analysis results using the learning model 221, or to save resources or time required for the generation of the learning model 221, the AI processor 215 may further include a data preprocessing unit 215b and/or a data selection unit 215c.

The data preprocessing unit 215b may preprocess the acquired data so that the acquired data can be used for learning/inference for determining a situation. For example, the data preprocessing unit 215b may extract feature information as preprocessing for input data acquired through the input device, and the feature information may be extracted in a format such as a feature vector, a feature point, or a feature map.

The data selection unit 215c may select data necessary for learning among learning data or learning data preprocessed in the preprocessing unit. The selected learning data may be provided to the model learning unit. As an example, the data selection unit 215c may select only data on an object included in a specific region as learning data by detecting the specific region among images acquired through a camera of the electronic device. In addition, the data selection unit 215c may select data necessary for inference among input data acquired through the input device or input data preprocessed by the preprocessing unit.

In addition, the AI processor 215 may further include a model evaluation unit 215d to improve the analysis result of the neural network model. When the model evaluation unit 215d inputs evaluation data to the neural network model and the analysis result output from the evaluation data does not satisfy a predetermined criterion, the model evaluation unit 215d may cause the model learning unit to relearn. In this case, the evaluation data may be predetermined data for evaluating the learning model 221. As an example, among the analysis results of the learned neural network model for evaluation data, when the number or ratio of evaluation data with inaccurate analysis results exceeds a predetermined threshold, the model evaluation unit 215d may evaluate that the predetermined criterion is not satisfied.

The communication module 270 may transmit the AI processing result by the AI processor 215 to an external electronic device.

In FIG. 5 above, it has been described that an example in which an AI process is implemented in a cloud environment due to computing operation, storage, and power constraints, but the present disclosure is not limited thereto, and the AI processor 215 may be implemented in a client device. FIG. 6 is an example in which AI processing is implemented in the client device, and is the same as illustrated in FIG. 5 except that the AI processor 215 is included in the client device.

FIG. 6 illustrates a schematic block diagram of an AI device according to another embodiment of the present disclosure.

The function of each configuration shown in FIG. 6 may refer to FIG. 5. However, since the AI processor is included in the client device 100, it may not be necessary to communicate with the server (200 in FIG. 5) in performing processes such as data classification/recognition, and accordingly, immediate or real-time data classification/recognition operation is possible. In addition, since there is no need to transmit the user's personal information to the server (200 in FIG. 5), the data classification/recognition operation for the purpose is possible without external leakage of the personal information.

On the other hand, each of the components shown in FIGS. 5 and 6 represents functional elements that are functionally divided, and it is noted that at least one component may be implemented in a form that is integrated with each other (e.g. an AI module) in an actual physical environment. It goes without saying that components not disclosed in addition to the plurality of components illustrated in FIGS. 5 and 6 may be included or omitted.

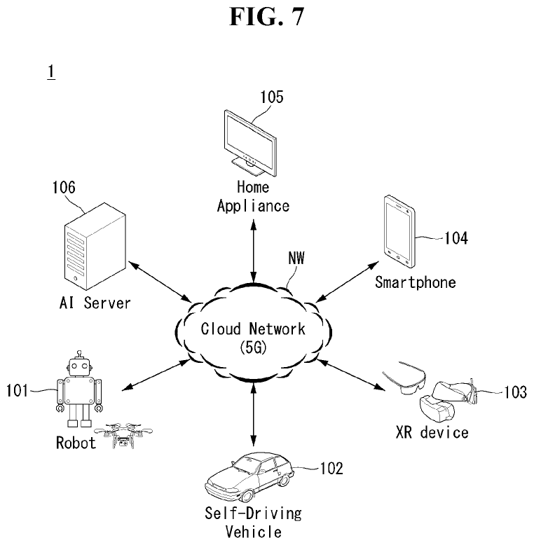

FIG. 7 is a conceptual diagram illustrating an embodiment of an AI device.

Referring to FIG. 7, in an AI system 1, at least one of an AI server 106, a robot 101, a self-driving vehicle 1002, an XR device 103, a smartphone 104, or a home appliance 105 are connected to a cloud network NW. Here, the robot 101, the self-driving vehicle 1002, the XR device 103, the smartphone 104, or the home appliance 105 applied with the AI technology may be referred to as the AI devices 101 to 105.

The cloud network NW may mean a network that forms a part of a cloud computing infrastructure or exists in the cloud computing infrastructure. Here, the cloud network NW may be configured using the 3G network, the 4G or the Long Term Evolution (LTE) network, or the 5G network.

That is, each of the devices 101 to 106 constituting the AI system 1 may be connected to each other through the cloud network NW. In particular, each of the devices 101 to 106 may communicate with each other through a base station, but may communicate directly with each other without going through the base station.

The AI server 106 may include a server performing AI processing and a server performing operations on big data.

The AI server 106 may be connected to at least one of the robots 101, the self-driving vehicle 1002, the XR device 103, the smartphone 104, or the home appliance 105, which are AI devices constituting the AI system, through the cloud network NW, and may assist at least some of the AI processing of the connected AI devices 101 to 105.

At this time, the AI server 106 may learn the artificial neural network according to the machine learning algorithm on behalf of the AI devices 101 to 105, and directly store the learning model or transmit it to the AI devices 101 to 105.

At this time, the AI server 106 may receive input data from the AI devices 101 to 105, infer a result value for the received input data using the learning model, generate a response or a control command based on the inferred result value and transmit it to the AI devices 101 to 105.

Alternatively, the AI devices 101 to 105 may infer the result value for the input data directly using the learning model, and generate a response or a control command based on the inferred result value.

<Exterior of Vehicle>

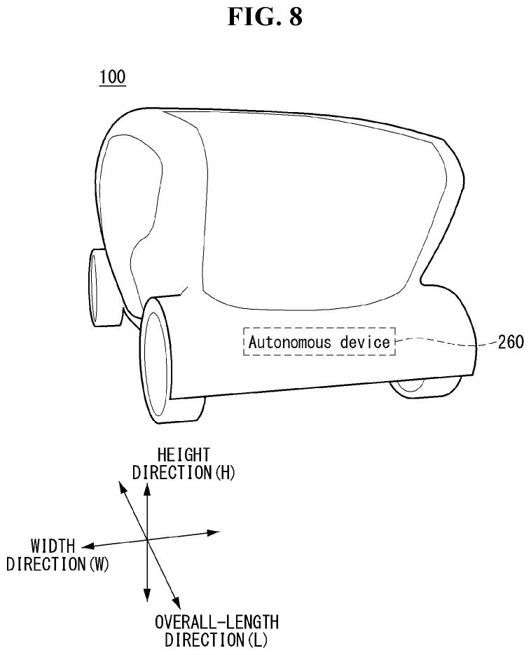

FIG. 8 is a diagram showing a vehicle according to an embodiment of the present disclosure.

Referring to FIG. 8, a vehicle 100 according to an embodiment of the present disclosure is defined as a transportation means traveling on roads or railroads. The vehicle 100 includes a car, a train and a motorcycle. The vehicle 100 may include an internal-combustion engine vehicle having an engine as a power source, a hybrid vehicle having an engine and a motor as a power source, and an electric vehicle having an electric motor as a power source. The vehicle 100 may be a private own vehicle. The vehicle 100 may be a shared vehicle. The vehicle 100 may be an autonomous vehicle.

<Components of Vehicle>

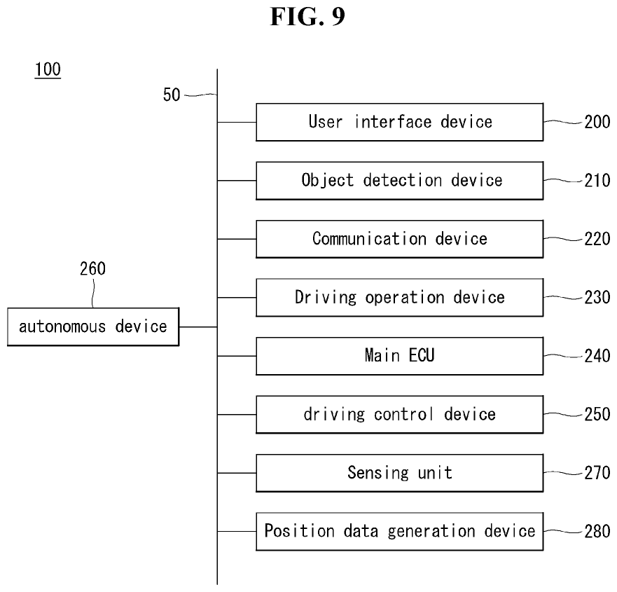

FIG. 9 is a control block diagram of the vehicle according to an embodiment of the present disclosure.

Referring to FIG. 6, the vehicle 100 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 100 and a user. The user interface device 200 can receive user input and provide information generated in the vehicle 100 to the user. The vehicle 100 can realize a user interface (UI) or user experience (UX) through the user interface device 200. The user interface device 200 may include an input device, an output device and a user monitoring device.

2) Object Detection Device

The object detection device 210 can generate information about objects outside the vehicle 100. Information about an object can include at least one of information on presence or absence of the object, positional information of the object, information on a distance between the vehicle 100 and the object, and information on a relative speed of the vehicle 100 with respect to the object. The object detection device 210 can detect objects outside the vehicle 100. The object detection device 210 may include at least one sensor which can detect objects outside the vehicle 100. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 100 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 100 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 100. A non-driven type lidar may detect an object positioned within a predetermined range from the vehicle according to light steering. The vehicle 100 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 100. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 100 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 100.

6) Driving Control Device

The driving control device 250 is a device for electrically controlling various vehicle driving devices included in the vehicle 100. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 100 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 100. The position data generation device 280 may include at least one of a global positioning system (GPS) and a differential global positioning system (DGPS). The position data generation device 280 can generate position data of the vehicle 100 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 100 may include an internal communication system 50. The plurality of electronic devices included in the vehicle 100 can exchange signals through the internal communication system 50. The signals may include data. The internal communication system 50 can use at least one communication protocol (e.g., CAN, LIN, FlexRay, MOST or Ethernet).

<Cabin System>

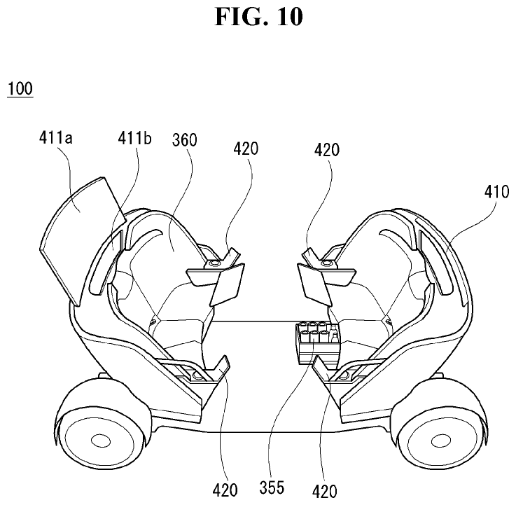

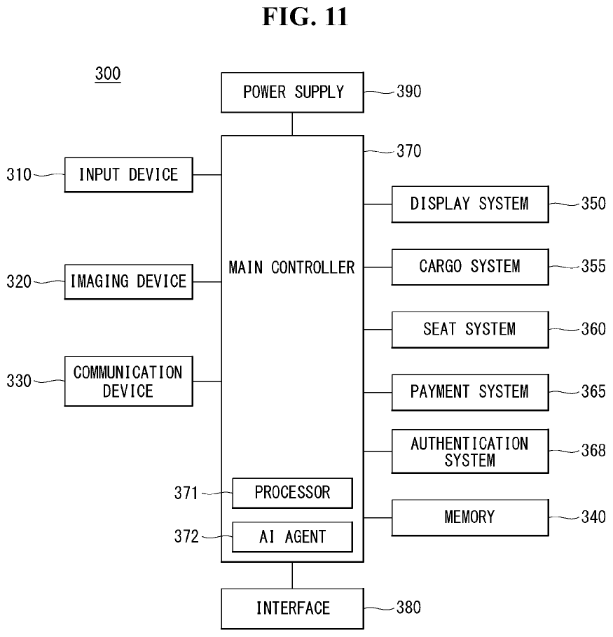

FIG. 10 is a diagram showing the interior of the vehicle according to an embodiment of the present disclosure. FIG. 11 is a block diagram referred to in description of a cabin system for a vehicle according to an embodiment of the present disclosure.

(1) Components of Cabin

Referring to FIGS. 10 and 11, a cabin system 300 for a vehicle (hereinafter, a cabin system) can be defined as a convenience system for a user who uses the vehicle 100. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 100 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 100 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 100. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

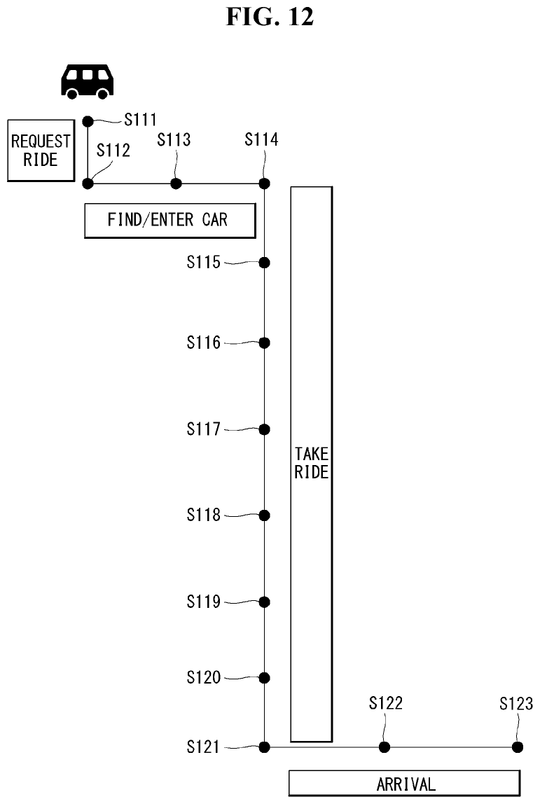

FIG. 12 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 100.

<Vehicle Microphone for Implementing Interactive Assistant>

The vehicle 100 may include a microphone at a location inside the vehicle 100 to perform a voice recognition and a control operation according to a result of the voice recognition. For example, the microphone may be installed in at least one of a dashboard, a ceiling, a console box, or an overhead console of the vehicle 100.

The microphones may be classified into an omni-directional microphone a and directional microphone based on the presence or absence of directionality. The omni-directional microphone can receive a sound from all directions around the microphone. The directional microphone can receive a sound in a specific direction from the microphone. The directional microphone may be classified into a unidirectional microphone and a bidirectional microphone. The unidirectional microphone refers to a microphone of which sensitivities of a front surface and a side surface based on a diaphragm of the microphone are higher than that of a rear surface. The bi-directional microphone refers to a microphone of which sensitivities on the front surface and rear surface based on the diaphragm are high. Meanwhile, a sub microphone array applied to various embodiments of present disclosure may include two or more microphones. As such, a sub microphone array including two or more microphones may be defined as a microphone array.

When the software processing for removing a noise is performed on the sound signal input through the microphone array, a beam can be formed in a specific direction from the microphone array based on the software processing. As such, a technique of forming the beam using the microphone array and displaying directionality in the formed beam direction is referred to as a beamforming technique.

When the directionality is formed in the direction in which the voice of the user is generated in the microphone array to which the beamforming technique is applied, energy corresponding to the voice signal input from directions outside the beam is attenuated, and the voice signal input from the beamforming region can be selectively obtained. The microphone array can suppress an engine noise of the vehicle 100, an environmental noise, and reflected waves reflected and generated from components inside the vehicle 100 and an inner wall of the vehicle 100 using the beamforming technique.

As an example, the microphone array can use the beamforming technique to obtain a higher signal to noise ratio (SNR) for voice signals generated from a beam in a direction of interest. Therefore, the beamforming plays an important role in spatial filtering, which points the “beam” to a sound source and suppresses all signals input from different directions.

A plurality of microphones applied to various embodiments of the present disclosure may be disposed at equal intervals or at unequal intervals to constitute the microphone array. The microphone array disposed in this way can selectively output only a sound signal generated from the sound source in a preset direction as described above, and remove a sound signal generated from the sound source in a direction not previously set.

A beamforming method for forming the beam in the specific direction can be largely divided into a fixed beamforming and an adaptive beamforming depending on whether or not input information is used. For example, the fixed beamforming is a method of compensating time-delay of a signal input for each channel by Delay and Sum Beamforming (DSB) to perform phase matching for a target signal. Moreover, the beamforming method includes a Least Mean Square (LMS) method and a Dolph-Chebyshev method. However, in the fixed beamforming, since weight of a beamformer is fixed by a position and frequency of the signal and an interval between channels, there may be a limitation that the fixed beamforming is not adaptive to the signal environment.

In contrast, the adaptive beamforming is designed to change the weight of the beamformer according to the signal environment. For example, the adaptive beamforming includes a Generalized Side-lobe Canceller (GSC) method and a Linearly Constrained Minimum Variance (LCMV) method. The GSC method may include the fixed beamforming, a target signal blocking matrix, and multiple interference cancellers. In the target signal blocking matrix, the voice signal is blocked using input signals and only the noise signal is output. By using the noise signals output from the target signal blocking matrix, the noise can be removed again from the output signal of the fixed beamforming in which the noise has already been removed once in the multiple interference canceller.

The microphone array according to various embodiments of the present disclosure may form a beam toward at least one of a plurality of seats of the vehicle 100. The microphone array may be installed in at least one of the dashboard, the ceiling, the console box, or the overhead console of the vehicle 100.

<Method of Providing Interactive Assistant>

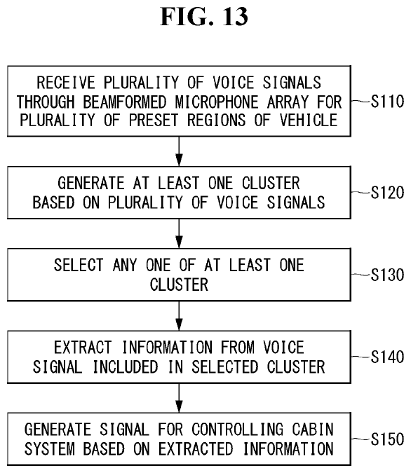

FIG. 13 is a flowchart illustrating a method of providing an interactive assistant for each seat in a vehicle according to an embodiment of the present disclosure.

Referring to FIG. 13, the vehicle 100 may receive a plurality of voice signals through a beamformed microphone array for a plurality of preset regions (S110). The plurality of preset regions may be determined based on the beam direction of the microphone array. Based on the setting of the microphone array, a region receiving a voice in the specific direction is defined the beamforming region.

Here, the specific direction means an input direction of a voice signal input through the microphone array from a position of any one of a plurality of seats located inside the vehicle 100.

In addition, the plurality of preset regions refers to a plurality of beamforming regions determined based on software processing for the microphone array. For example, the plurality of preset regions may include regions mapped to the plurality of seats disposed inside the vehicle 100. As a result, the vehicle 100 may receive a voice of a user who has boarded the plurality of seats disposed inside the vehicle 100 through a microphone array. In addition, the vehicle 100 may filter a voice received from a region other than the beamforming region with noise.

The microphone array according to various embodiments of the present disclosure may include two or more microphones. As an example, in the case of a two-seater vehicle 100, the microphone array may include two microphones. In this case, the microphone array may be software-processed such that the beamforming region is set to be mapped to a first seat and a second seat of the two-seater vehicle 100. As another example, in the case of the four-seater vehicle 100, the microphone array may include four microphones. In this case, the microphone array may include a first sub microphone array and a second sub microphone array including two microphones. In the first sub microphone array, the beamforming regions are set in two seats of the seats located inside the vehicle 100, and in the second sub microphone array, the beamforming regions are set in two other seats which are not mapped by the first sub microphone array. However, the number of seats is not limited to this as an example, and the beamforming region may be set according to an expected number of occupants.

In addition, the microphone array according to various embodiments of the present disclosure may be beamformed into a plurality of regions based on super-directive beamforming which is one of the fixed beamforming methods.

As such, the vehicle 100 may receive a voice from the seat of the vehicle 100 mapped to a plurality of beamforming regions using at least one microphone array in which the beamforming region is preset.

The vehicle 100 may generate at least one cluster based on a plurality of voice signals (S120). The generated cluster is clustered based on the acoustic characteristics of the voice signal. The acoustic characteristics may include a frequency, energy, and/or a waveform of the signal. The generated cluster may include a plurality of voice signals having similar acoustic characteristics.

The vehicle 100 may select any one of at least one cluster through the processor (S130). A plurality of voice signals included in the cluster generated in S120 are regarded as a voice signal of a specific user and can be used as an input of a subsequent interactive assistant. Accordingly, the vehicle 100 may select any one of the at least one cluster through the processor and use a voice signal corresponding to or included in the selected cluster as input voice signal or voice data.

The vehicle 100 may extract information from the voice signal included in the selected cluster through the processor (S140). Specifically, the vehicle 100 may analyze the acoustic characteristics of the voice signal and predict a user corresponding to the analysis result. In this case, the vehicle 100 may generate or extract user information indicating a specific user from the voice signal according to the prediction result. The user information and the user identification information can be used interchangeably with each other.

The vehicle 100 may generate a signal for controlling the cabin system 300 based on the extracted information (S150). Here, the extracted information refers to the user information described in S140. The vehicle 100 may provide a customized service based on the extracted user information. The signal for controlling the cabin system 300 refers to a signal for controlling at least one component provided in the cabin system 300 for the vehicle 100. For example, the vehicle 100 may provide an optimized cabin system 300 in response to a specific user based on the user information. Specifically, the vehicle 100 may provide a user with an angle of a seat, a temperature of a seat, a display channel, or the like preferred by a specific user, without manual manipulation of the user.

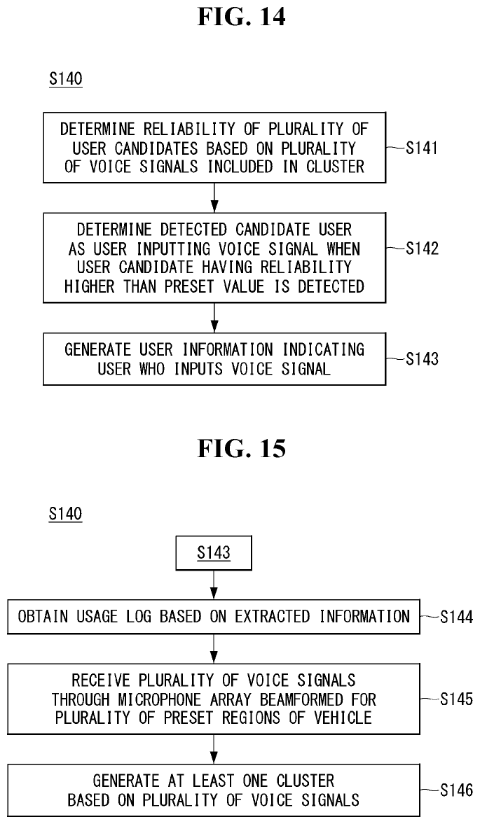

FIG. 14 is a flowchart illustrating an example of S140 in FIG. 13 of the present disclosure.

Referring to FIG. 14, the vehicle 100 may determine reliability of a plurality of user candidates based on the plurality of voice signals included in the cluster through the processor (S141). In this case, the vehicle 100 may use a pre-trained user authentication model. The user authentication model refers to a model that has previously trained the plurality of user candidates and biometric information of a specific user as learning data. In this case, the user authentication model may be implemented as a neural network model. When the biometric information (for example, voice signal) of a specific user is input to the vehicle 100, the vehicle 100 may calculate reliability of each of the plurality of user candidates based on the input biometric information.

When a user candidate having a reliability higher than a preset value is detected through the processor, the vehicle 100 may determine the detected candidate user as a user inputting a voice signal (S142). The vehicle 100 may generate user information indicating a user who inputs a voice signal (S143).

FIG. 15 is a flowchart illustrating another example of S140 in FIG. 13 of present disclosure.

Referring to FIG. 15, the vehicle 100 may obtain a usage log based on the extracted information (S144). The usage log is recorded in association with the user information. For example, the usage log of “USER A” is recorded in database associated with the “USER A”. The vehicle 100 may receive a usage log matching the user information from the network using the information extracted through S141 to S143 of FIG. 14. The usage log includes usage information for each of a plurality of services that can be provided through the cabin system 300 for the vehicle 100. The usage information includes a usage time, a usage cycle, a usage method, or the like. The obtained usage log can be used to calculate preferences for each of the plurality of services which can be provided through the cabin system 300 for the vehicle 100 afterwards.

The vehicle 100 may receive the plurality of voice signals through the microphone array beamformed for a plurality of preset regions of the vehicle 100 (S145). The plurality of preset regions correspond to a plurality of seat positions provided inside the vehicle 100. The microphone array may be beamformed to correspond to each of the plurality of seats located inside the vehicle 100. In an embodiment, the microphone array installed in the vehicle 100 is software-processed in a fixed beamforming method.

The vehicle 100 may generate at least one cluster based on the plurality of voice signals (S146). For example, since a voice signal generated from a first occupant located in the first seat includes the acoustic characteristics of the first occupant, when the clustering is performed based on the acoustic characteristics, the voice signal of the first occupant can be divided into one cluster. As such, since the voice signal of each of the plurality of occupants has similar characteristics, the vehicle 100 can separate the sound sources of the plurality of occupants by performing the clustering method. In an embodiment of the present disclosure, the vehicle 100 may perform the clustering based on a deep clustering method.

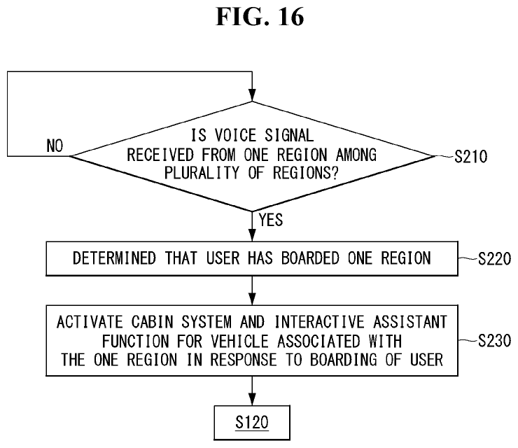

FIG. 16 is a flowchart illustrating a method of controlling activation of an interactive assistant function of the present disclosure.

Referring FIG. 16, when the voice signal is received from one region among the plurality of regions (S210: YES), it may be determined that a user has boarded the one region (S220). However, when the voice signal is not received, it may be determined that the user has not boarded.

The vehicle 100 may activate the cabin system 300 and the interactive assistant function for the vehicle 100 associated with the one region in response to the boarding of the user (S230). The vehicle 100 maintains the cabin system 300 for the vehicle 100 so that the cabin system 300 is in an inactive state in the seat on which the user has not boarded. Accordingly, power consumption can be minimized. In addition, when the interactive assistant function is activated in response to the boarding of the user, the vehicle 100 may output a cipher text for user confirmation in response to the activation of the assistant function. For example, when the user sits on a specific seat and utters “HI LG”, the vehicle 100 may output a cipher text (for example: “UMYEON?”) through a speaker. In this case, the vehicle 100 may activate the cabin system 300 which matches the user upon receiving a correct answer (“Artificial Intelligence Lab”) matching the cipher text from the user.

The method of controlling the activation of the interactive assistant function according to various embodiments of present disclosure may match a plurality of voice signals received in response to the activation of the assistant function or the location information of the activated region in at least one cluster. As such, the matched information can be used to provide a customized service corresponding to the user. Specifically, the user may have different preferred services according to the position of the seat inside the vehicle. To solve this problem, the location information is matched or combined with the cluster or voice signal, and then used to provide the assistant function.

In the following specification, the method of providing the interactive assistant for each seat in the vehicle 100 described above with reference to FIGS. 13 to 16 will be applied to the vehicle 100 so as to be described.

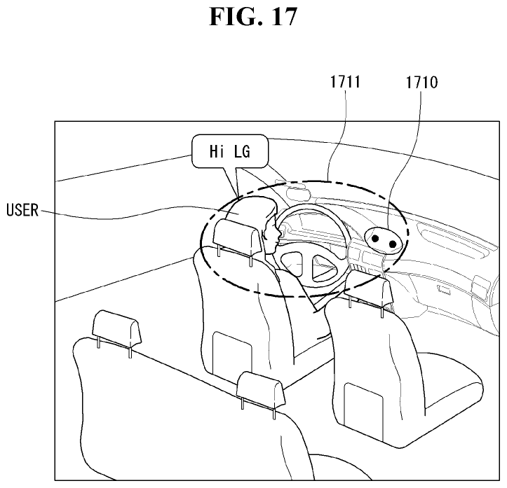

FIGS. 17 to 19 are views for explaining an exemplary implementation of the beamforming method.

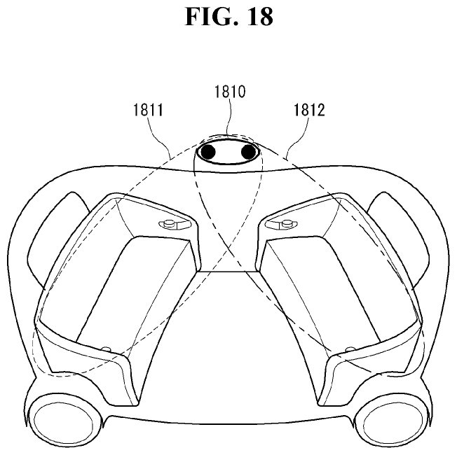

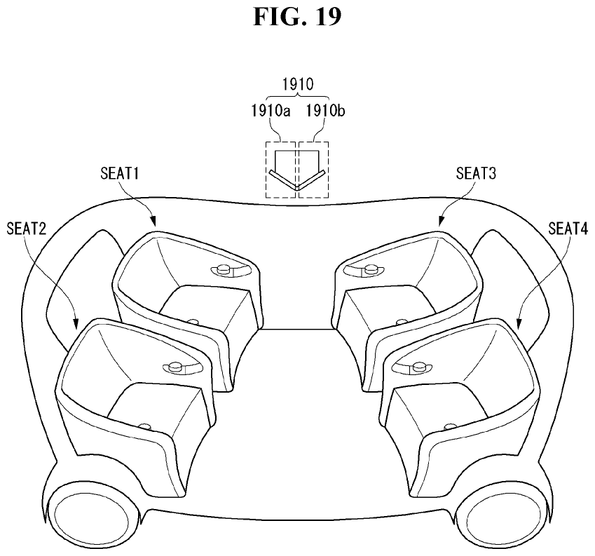

FIG. 17 illustrates an example in which a plurality of seats disposed inside the vehicle 100 are disposed to face a traveling direction of the vehicle 100. FIGS. 18 and 19 illustrate an example in which a plurality of seats disposed inside the vehicle 100 are disposed to face each other. Specifically, FIG. 18 illustrates a two-seater vehicle 100, and FIG. 19 illustrates a four-seater vehicle 100, but various embodiments of present disclosure are not limited to the number of seats in the vehicle 100.

Referring to FIG. 17, a microphone array 1710 may be installed in a dashboard of the vehicle 100. However, the location where the microphone array 1710 is installed is not limited to the dashboard, and may be installed in at least one of a ceiling, a console box, or an overhead console. The microphone array 1710 may be beamformed to receive a voice signal from a driver's seat and/or a passenger seat. In this case, a region to be beamformed may be defined as a beamforming region 1711. At this time, the microphone array 1710 is beamformed using a fixed beamforming method. As such, the microphone array 1710 is disposed at a position adjacent to the occupant's seat, and thus, can receive the voice signal from the user.

However, in the case of the vehicle 100 of FIG. 17, the microphone array 1710 is installed in the dashboard. Accordingly, it is possible to receive the voice signal of the driver's seat and/or the passenger seat, but it is difficult to receive the voice signal from the occupants on a rear seat. In this case, the microphone array 1710 for the occupants of the rear seat may be additionally installed in the console box or the ceiling, but a structural problem of a circuit and a problem in design cost may occur. To solve this problem, the present disclosure proposes the vehicle 100 structure of FIGS. 18 and 19, which will be described later.

Referring to FIGS. 18 and 19, the plurality of seats of the vehicle 100 may be disposed to face each other. The vehicle 100 of FIG. 18 is a vehicle 100 having two seats. Referring to FIG. 18, the vehicle 100 may include two seats facing each other. A microphone array 1810 for receiving the voice signal of the occupant from the seat of the vehicle 100 is installed on the ceiling of the vehicle 100. The microphone array 1810 may include two or more microphones. The beam forming region pre-processed in the microphone array 1810 includes a first region 1811 which focuses the first seat and a second region 1812 which faces the first seat and focuses the second seat.

The vehicle 100 may distinguish the voice signals received from the first region 1811 and the second region 1812. For example, in order to receive distinguishingly only a signal input in a specific direction using a time delay generated between the signal input from the first region 1811 and the signal input from the second region 1812, the vehicle 100 may receive the signal in a state where an inflow direction of the signal is fixed.

Referring to FIG. 19, three or more seats (for example, four seats) of the vehicle 100 may be disposed to face each other. FIG. 19 exemplarily illustrates the vehicle 100 including first to fourth seats SEAT1, SEAT2, SEAT3, and SEAT4, but the embodiment of the present disclosure is not limited to the number of seats. The first sheet SEAT1 is disposed side by side with the second sheet SEAT2, and the third sheet SEAT3 is disposed side by side with the fourth sheet SEAT4. The first sheet SEAT1 is disposed to face the third sheet SEAT3, and the second sheet SEAT2 is disposed to face the fourth sheet SEAT4.

A microphone array 1910 may be disposed in a central region of a plurality of seats based on the positions of the plurality of seats constituting the inside of the vehicle 100. Specifically, the microphone array 1910 may be disposed in a center inside the vehicle 100. For example, the microphone array 1910 may be installed in a ceiling space between the first SEAT1 to the fourth seat SEAT4. Meanwhile, the position of the microphone array 1910 is not necessarily limited to being installed in the ceiling space, and although not illustrated in FIG. 19, if the console box is installed between the first seat SEAT1 to the fourth seat SEAT4, the microphone array 1910 is also installed in the console box.

The microphone array 1910 according to an embodiment of the present disclosure may include a first sub microphone array 1910a and a second sub microphone array 1910b. Each of the first sub microphone array 1910a and the second sub microphone array 1910b is the microphone array 1910 which includes two or more microphones.

FIGS. 20 to 26 are exemplary views illustrating an implementation of a method of providing an interactive assistant.

Referring to FIG. 20, a first sub microphone array 2010a may be beamformed to a region mapped to at least one seat located in one region of the vehicle 100, and a second sub microphone array 2010b may be beamformed to a region mapped to at least one seat located in another region of the vehicle 100. Specifically, the first sub microphone array 2010a may form beam forming regions in a first region 2011 associated with the first seat SEAT1 and the second region 2012 associated with the second seat SEAT2, respectively. The second sub microphone array 2010b may form beam forming regions in a third region 2013 associated with the third sheet SEAT3 and a fourth region 2014 associated with the fourth sheet SEAT4, respectively.

The microphone array 2010 simply including two microphones has difficulty in distinguishing the input directions of the voice signals of three or more seats. Accordingly, in order to distinguishingly receive the voice signals of three or more regions, the plurality of sub microphone arrays 2010a and 2010b are necessary. In the vehicle 100 according to an embodiment of the present disclosure, the beamforming region for each of the plurality of seats is formed, and thus, it is possible to distinguishingly receive the voice signal from each of a plurality of users.

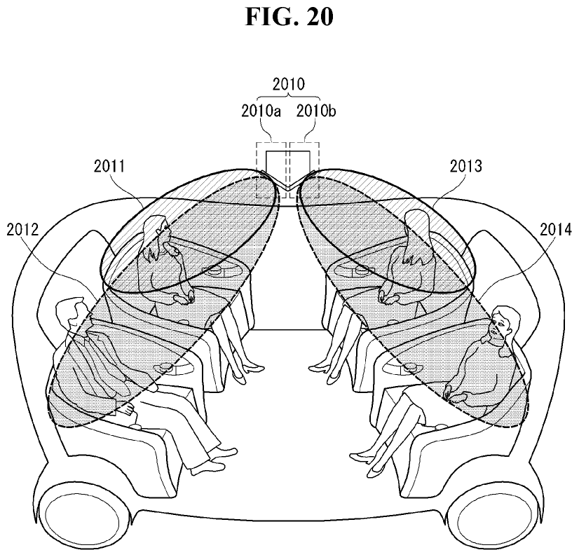

Referring to FIG. 21, the vehicle 100 may receive a first voice input 2091 from the occupant located in the second region 2012 through the microphone array 2010. In this case, the first voice input 2091 is a signal generated from the beamformed second region 2012. The first sub microphone array 2010a may receive the first voice input 2091 based on a pre-formed beamforming region. The vehicle 100 may control the cabin system 300 for the vehicle 100 based on the first voice input 2091 of the occupant received through the first sub microphone array 2010a. For example, when the occupant inputs the voice “HI LG, turn on TV”, the vehicle 100 may control the display of the cabin system 300 so that the cabin system 300 is turned on in response to a starting word (“HI LG”) and a command (“turn on TV”).

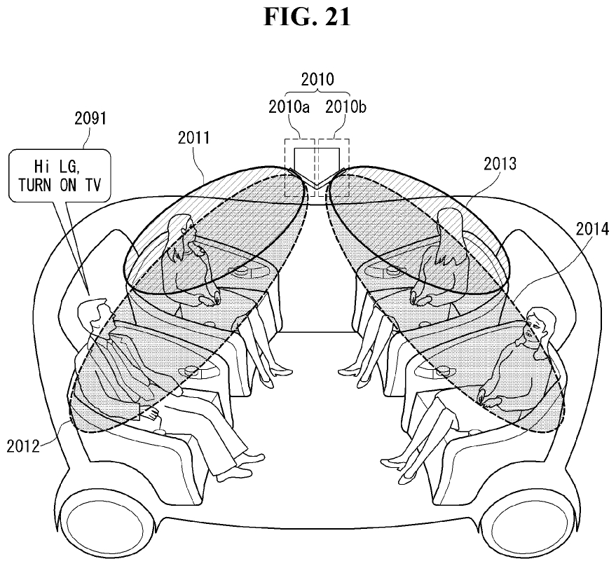

FIG. 22 is a view for explaining an example of a method of providing the interactive assistant by the plurality of occupants. Referring to FIG. 22, first to fourth occupants USER1, USER2, USER3, and USER4 are on board the first to fourth seats SEAT1, SEAT2, SEAT3, and SEAT4 of the vehicle 100, respectively, and the beamforming of the microphone array 2010 is set for the first to fourth regions 2011, 2012, 2013, and 2014 mapped to the fourth to fourth seats SEAT1, SEAT2, SEAT3, and SEAT4. That is, the microphone array 2010 may receive the voices of the first to fourth occupants USER1, USER2, USER3, and USER4 who are on board the first to fourth seats SEAT1, SEAT2, SEAT3, and SEAT4, respectively, and may process voice signals received from regions other than the preset beamforming region as a noise.

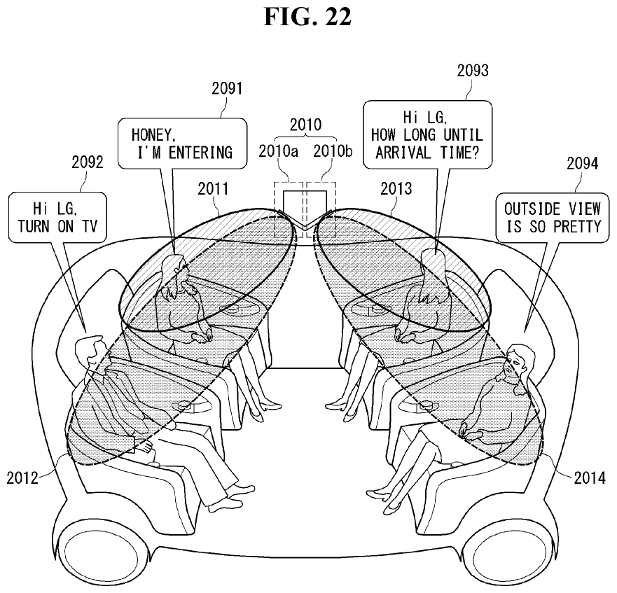

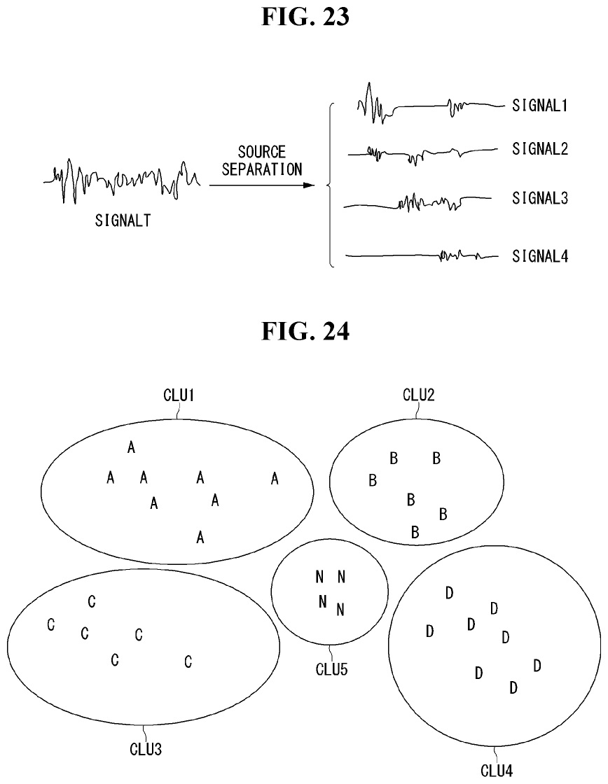

In this case, the vehicle 100 may receive the voice signals of the first to fourth occupants USER1, USER2, USER3, and USER4 through the microphone array 2010 including the first and second sub microphone arrays 2010a and 2010b. For example, the first sub microphone array 2010a may receive the voice input (“ . . . honey, I'm entering”, 2091) of the first occupant USER1 and the voice input (“HI LG, turn on TV”, 2092) of the second occupant USER2, based on the beamforming regions. In addition, the second sub microphone array 2010b may receive the voice input (“HI LG, how long until arrival time?”, 2093) of the third occupant USER3 and the voice input (“outside view is so pretty”, 2094) of the fourth occupant USER4, based on the beamforming region. In this case, the voice inputs of the first to fourth occupants USER1, USER2, USER3, and USER4 received through the microphone array 2010 may be divided by a source separation algorithm (for example, Blind Source Separation, BSS). (refer to FIG. 23).

Referring to FIG. 23, the sources input through the microphone array 2010 may be source-separated into the voice signals of the first to fourth occupants USER1, USER2, USER3, and USER4. For example, the sources input through the microphone array 2010 may be separated into first to fourth signals SIGNAL1, SIGNAL2, SIGNAL3, and SIGNAL4 corresponding to voice inputs of the first to fourth occupants USER1, USER2, USER3, and USER4, respectively. The source separation algorithm is obvious to a person skilled in the art, and thus, is omitted.

Referring to FIG. 24, the vehicle 100 may cluster the plurality of voice signals based on the acoustic characteristics (for example, waveform, frequency, energy, or the like). As a result of the clustering, the plurality of voice signals input from the plurality of occupants may be clustered into a plurality of clusters based on the similarity of the acoustic characteristics. That is, a plurality of voice signals included in each cluster may have similar acoustic characteristics. Therefore, the voice signal included in the cluster can be distinguished from the voice signals and/or the noise of other occupants having relatively dissimilarity. Thus, for example, voice signals generated by occupants A to D may constitute first to fourth clusters CLU1, CLU2, CLU3, and CLU4. In addition, a noise signal generated by a surrounding environment, an engine noise, or the like of the vehicle 100 may constitute a fifth cluster CLU5. As described above, the plurality of voice signals can be distinguished from each other based on the similarity of acoustic characteristics by clustering. The separated signals may be inputted separately from different signals in the subsequent voice recognition through the interactive assistant. As a result, the vehicle 100 may reduce a false recognition rate generated by the plurality of occupants inputting the voice signals in a closed space.

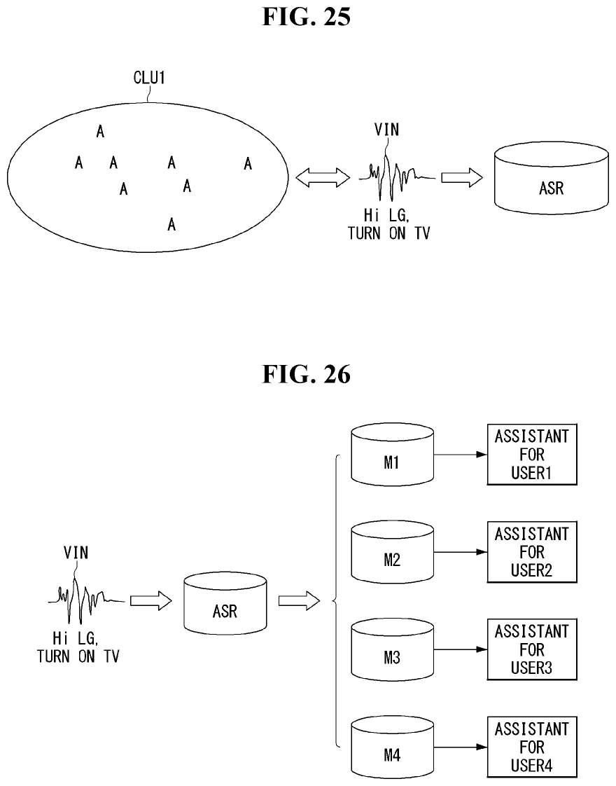

Referring to FIG. 25, for example, the vehicle 100 may select the first cluster among the plurality of clusters. The selected first cluster CLU1 includes the voice signal of the occupant A clustered based on the acoustic characteristics. When the vehicle 100 receiving the voice input (“HI LG, turn on TV”) associated with the acoustic characteristics of the first cluster CLU1, the vehicle 100 may perform an automatic speech recognition ASR process in response to the received voice input. Here, the ASR may be performed based on a previously generated or received ASR model. The first cluster CLU1 is a cluster formed based on the acoustic characteristics of the occupant A, and thus, the first cluster CLU1 rarely includes the noise and/or the voice signals of acoustic characteristics of other occupants. Therefore, the vehicle 100 uses the voice signal VIN associated with the first cluster CLU1 as a voice input after the first cluster CLU1 is selected, and thus, the vehicle 100 according to an embodiment of the present disclosure can exclude the noise and/or the voice inputs of other occupants.

Referring to FIG. 26, the vehicle 100 may check the user information of the occupant corresponding to the input voice. The input voice may have different acoustic characteristics for each occupant. Accordingly, the vehicle 100 may distinguish any one of the plurality of users based on the acoustic characteristics. The user information may be stored in advance in the memory of the vehicle 100 or a server which can communicate with the vehicle 100. The vehicle 100 may request the user to perform a registration procedure when the user information is not stored in advance.

The vehicle 100 may extract the user information when the user information is confirmed. The extracted user information may be used to select user models M1, M2, M3, and M4 later. The user model M1, M2, M3, and M4 refers to a model trained to provide a service in the order of the size of preference of a specific user. In an embodiment, the user models M1, M2, M3, and M4 are pre-trained with the supervised learning method to provide a specific service in order of the user preference. For example, the user model M1, M2, M3, and M4 sets the identified user information as an input, and the user preference for each of the plurality of services that can be provided through the cabin system 300 for the vehicle 100 may be set to an output to be trained.

In this case, the user preference for each of the plurality of services may be determined based on the usage log of a specific user. Specifically, the user model may be a learning model in which a parameter (for example, weight) is adjusted so that a higher preference is given to a service having a high use frequency of the user.

As an example, by analyzing usage logs, the preference is calculated high as the number of uses of the user is high for any one of the plurality of services, and the preference is calculated low as the number of uses thereof is low. The user model may be updated continuously or periodically based on the usage log of the user. Meanwhile, FIG. 26 illustrates four user models, but the user model is not limited thereto.

As described above, the method of providing the interactive assistant for each seat in the vehicle 100 according to various embodiments of the present disclosure use the beamforming microphones and the clustering techniques to effectively remove the noise and the voices of other persons, and thus, can provide the interactive assistant to the specific user who is on board the specific seat.

Moreover, the interactive assistant of the related art cannot provide different services by receiving only voice input by the user in a specified region or by classifying a plurality of regions. However, even if the plurality of occupant who are on board the plurality of seats simultaneously emit different voice inputs, the method of providing the interactive assistant for each seat in the vehicle 100 according to various embodiments of the present disclosure may classify and process the voice inputs.

The present disclosure described above can be embodied as computer readable codes on a medium in which a program is recorded. The computer-readable medium includes all kinds of recording devices in which data which can be read by a computer system is stored. Examples of the computer-readable media include a hard disk drive (HDD), a solid state disk (SSD), a silicon disk drive (SDD), a ROM, a RAM, a CD-ROM, a magnetic tape, a floppy disk, and an optical data storage device, and also include a media which are implemented in the form of a carrier wave (for example, transmission over the Internet). Accordingly, the above detailed description should not be construed as limiting in all respects, but should be considered illustrative. A scope of the present disclosure should be determined by the rational interpretation of the appended claims, and all changes within the equivalent scope of the present disclosure are included in the scope of the present disclosure.

What is claimed is:

1. A method comprising:
receiving a voice signal through a microphone array for a plurality of regions in a vehicle;
generating at least one cluster based on acoustic characteristics of a plurality of voice signals;
selecting a cluster associated with the received voice signal among the plurality of voice signals in a specific direction, wherein the cluster is selected among the at least one cluster, and
extracting information from the received voice signal included in the selected cluster; and
generating a control signal corresponding to the extracted information.

2. The method of claim 1, wherein the microphone array is disposed in a central region with respect to a plurality of seats based on positions of the plurality of seats inside of the vehicle.

3. The method of claim 2, wherein the microphone array is disposed inside of the vehicle.

4. The method of claim 2, wherein the specific direction corresponds to an input direction of the received voice signal transmitted from a position of any one of the plurality of seats toward the microphone array.

5. The method of claim 2, wherein the microphone array is beamformed to respective positions of the plurality of seats.

6. The method of claim 2, wherein the microphone array comprises:
a first sub microphone array comprising first and second microphones beamformed to a first region mapped to at least one seat located at a first region of the vehicle, and
a second sub microphone array comprising third and fourth microphones beamformed to a second region mapped to at least one seat located at a second region of the vehicle.

7. The method of claim 6, wherein the at least one seat located in the first region faces the at least one seat located in the second region.

8. The method of claim 1, wherein the extracted information comprises user identification information detected from utterance characteristics of a user, and wherein the generated control signal controls at least one component provided in a vehicle cabin system.

9. The method of claim 8, wherein generating the control signal further comprises selecting a user model matching the extracted information, wherein the generated control signal controls the vehicle cabin system to provide a specific service in an order of preference of the user according to the selected user model, and
wherein the user model is a learning model based on an artificial neural network configured to output a user preference for a plurality of services provided through the vehicle cabin system based on an input of the user identification information.

10. The method of claim 9, wherein the user model corresponds to a learning model in which weights are adjusted such that a higher preference is proportionally given to a service with a high use frequency.

11. The method of claim 1, wherein the microphone array is beamformed to the plurality of regions based on Super-directive Beamforming.

12. The method of claim 1, further comprising:
based on the received voice signal from one region of the plurality of regions, determining that a user boards one region in response to receiving the voice signal from the user; and
activating a vehicle cabin system associated with the one region in response to the user boarding.

13. The method of claim 12, further comprising combining location information of the one region with the received voice signal or the at least one cluster.

14. A vehicle comprising:
a microphone array configured to be beamformed to a plurality of regions preset in the vehicle; and
a controller configured to:
generate at least one cluster based on acoustic characteristics of a plurality of voice signals received from the microphone array,
select a cluster associated with the received voice signal among the plurality of voice signals in a specific direction,
extract information from the received voice signal included in the selected cluster, and generate a control signal corresponding to the extracted information.

15. The vehicle of claim 14, wherein the microphone array is disposed in a central region with respect to a plurality of seats based on positions of the plurality of seats inside the vehicle.

16. The vehicle of claim 15, wherein the microphone array is disposed inside of the vehicle.

17. The vehicle of claim 15, wherein the specific direction corresponds to an input direction of the received voice signal transmitted from a position of any one of the plurality of seats toward the microphone array.

18. The vehicle of claim 15, wherein the microphone array is beamformed to respective positions of the plurality of seats.

19. The vehicle of claim 15, wherein the microphone array comprises:
a first sub microphone array comprising first and second microphones beamformed to a first region mapped to at least one seat located at a first region of the vehicle, and
a second sub microphone array comprising third and fourth microphones beamformed to a second region mapped to at least one seat located at a second region of the vehicle.

20. A machine-readable non-transitory medium having stored thereon machine-executable instructions, the instructions comprising:
receiving a voice signal through a microphone array for a plurality of regions in a vehicle;
generating at least one cluster based on acoustic characteristics of a plurality of voice signals;
selecting a cluster associated with the received voice signal among the plurality of voice signals in a specific direction, wherein the cluster is selected among the at least one cluster, and
extracting information from the received voice signal included in the selected cluster; and
generating a control signal corresponding to the extracted information.
